(19) United States
(12) Patent Application Publication
(10) Pub. No.: US 2026/0167074 A1
(43) Pub. Date: Jun. 18, 2026

(54) LUMBAR CUSHION

(71) Applicant: Guangzhou Qiaoluojia Technology Co.Ltd., Guangzhou (CN)

(72) Inventor: ZHONGLI HUANG, Foshan City (CN)

(21) Appl. No.: 18/979,607

(22) Filed: Dec. 13, 2024

(51) Int. Cl. B60N 2/66

(52) U.S. Cl. CPC B60N 2/665

(57) ABSTRACT

This invention discloses a lumbar cushion includ ing a lumbar cushion front panel, a lumbar cushion back shell, an airbag module, a control panel, a fixing clip, and a vibration module. By providing a hook body, a hook slot, a latch slot, and a latch hook body, the front panel can be conveniently fixed to one side of the back shell. Reverse operation allows the front panel to be separated from the back shell, facilitating maintenance of equipment or components between the front panel and the back shell. By incorporating an air pump body, an airbag module, and a vibration module, the air pump body can inflate the airbag module to support the lumbar and back area of the driver. Vibrations generated by the vibration module can provide massage of varying intensities to the lumbar and back area of the driver, thereby improving the comfort of the driver.

### BACKGROUND OF THE INVENTION

### FIELD OF THE INVENTION

This invention relates to the technical field of lumbar cushions, specifically to a lumbar cushion.

### DESCRIPTION OF RELATED ART

Lumbar cushions, also referred to as lumbar supports, driver seat backrests, or car cushions, provide essential support and protection for the lumbar region of drivers, ensuring comfort and health during driving. Existing lumbar cushions are made from various materials, such as down, foam, latex, etc. These materials not only provide necessary lumbar support and protection but also significantly enhance driving comfort and safety.

However, there are still some shortcomings in existing lumbar cushion technology.

### 1. Memory Foam Issues:

Most lumbar cushions in existing technology use memory foam, which automatically adjusts its shape according to the driver’s weight and posture to provide more fitting support. However, as the elasticity of memory foam deteriorates over time, the cushion can no longer conform effectively to the driver’s lumbar and back, reducing its support performance.

### 2. Limited Functionality:

Existing lumbar cushions generally have a simple structure, leading to limited functionality. They are unable to offer additional features like heating and massage, which results in poor comfort for the driver’s lumbar and back areas.

### 3. Non-Detachable Design:

Most lumbar cushions in existing technology are made as a single integrated piece, where the front and back cannot be disassembled or separated. This makes it inconvenient to maintain or service the internal materials.

To address these issues, the inventors propose a lumbar cushion to overcome the aforementioned problems.

### SUMMARY OF THE INVENTION

To address the issues of poor comfort and the inability to detach the front and back of lumbar cushions, the invention aims to provide an improved lumbar cushion.

To solve the above technical problems, the invention adopts the following technical solution:

A lumbar cushion includes a front panel and a back shell. The back shell is detachably mounted on one side of the front panel.

The back shell is equipped with an airbag mounting position, a first fan mounting position, a second fan mounting position, an air pump mounting position, a circuit board mounting position, and an air valve mounting position. There are three airbag mounting positions, each of which is fixedly installed with an airbag module. The first fan mounting position is fixedly installed with a first fan, and the second fan mounting position is fixedly installed with a second fan. The air pump mounting position is fixedly installed with an air pump body, which is connected to the airbag module via pipelines. The circuit board mounting position is fixedly installed with a circuit board body, and the air valve mounting position is fixedly installed with an air valve body, which is also connected to the airbag module via pipelines. The front panel is provided with several air duct grooves, corresponding to the second fan.

The side of the back shell facing away from the front panel is equipped with an air guide plate, and the side of the front panel facing away from the back shell is equipped with three soft cushions. Each airbag module is fixedly installed with a vibration module. The circuit board body is electrically connected to the first fan, second fan, air pump body, airbag module, and vibration module via wires.

### Preferred Features

1. The front panel is provided with two hook bodies, and the back shell is equipped with two hook slots, with the hook bodies and hook slots being detachably connected.

2. The front panel is provided with two symmetrically distributed latch slots, while the back shell is equipped with two symmetrically distributed latch hook bodies, with the latch hook bodies and latch slots being detachably connected.

3. The front panel is fixedly installed with a control panel, which is electrically connected to the circuit board body via wires.

4. One end of the back shell is fixedly installed with a fixing clip.

5. The middle part of the air guide plate is provided with two front air inlets in a honeycomb pattern, while both ends are equipped with side air inlets. The air guide plate also features two air valve exhaust holes corresponding to the exhaust ports of the air valve body.

6. The soft cushions correspond to the airbag modules, with each soft cushion provided with several evenly distributed air outlets.

7. The vibration module includes a fixing strap and a power cord fastening clip, with the vibration module being fixedly installed on the airbag module via the fixing strap. The power cord fastening clip secures the power cord of the vibration module.

### Advantages Over Existing Technology

1. The invention facilitates the attachment of the front panel to one side of the back shell through the use of hook bodies, hook slots, latch slots, and latch hook bodies. Reverse operation allows for the separation of the front panel from the back shell, enabling convenient maintenance of components or devices between the two parts.

2. By incorporating an air pump body, airbag modules, and vibration modules, the air pump body inflates the airbag modules, which support the driver’s lumbar and back. The vibration modules provide massages of varying intensities, enhancing lumbar and back comfort during driving.

3. Through the combined action of the first and second fans, the second fan heats the incoming air, and the first fan generates a high-speed flow of hot air. This high-temperature airflow is directed toward the driver’s lumbar and back via the air outlets, achieving heating and further improving driving comfort.

### BRIEF DESCRIPTION OF THE DRAWINGS

To provide a clearer explanation of the technical solutions in the embodiments of this invention or prior art, a brief introduction to the drawings used in the description of the embodiments or prior art is provided below. It is evident that the following drawings represent only some embodiments of this invention. For those skilled in the art, other drawings can be derived from these without creative efforts.

FIG. 1 is a schematic diagram of the structure of the front panel of the lumbar cushion in this invention.

FIG. 2 is a schematic diagram of the structure of the back shell of the lumbar cushion in this invention.

FIG. 3 is a schematic diagram of the structure of the first fan, second fan, and air pump body in this invention.

FIG. 4 is a schematic diagram of the air guide plate, airbag module, and soft cushion in relation to the back shell of the lumbar cushion in this invention.

FIG. 5 is a schematic diagram of the air guide plate, control panel, back shell, and front panel of the lumbar cushion in this invention.

FIG. 6 is a schematic diagram of the connection structure between the vibration module and the airbag module in this invention.

FIG. 7 is a schematic diagram of the structure of the soft cushion in this invention.

### REFERENCE NUMBERS IN THE DRAWINGS:

10: Front panel of the lumbar cushion

20: Back shell of the lumbar cushion

30: Airbag module

40: Control panel

50: Fixing clip

60: Vibration module

11: Hook body

12: Latch slot

13: First fan

14: Second fan

15: Air pump body

16: Circuit board body

17: Air valve body

18: Air duct groove

21: Hook slot

211: Latch hook body

22: Airbag mounting position

23: First fan mounting position

24: Second fan mounting position

25: Air pump mounting position

26: Circuit board mounting position

27: Air valve mounting position

28: Air guide plate

281: Front air inlet

282: Side air inlet

283: Air valve exhaust hole

29: Soft cushion

291: Air outlet

61: Fixing strap

62: Power cord fastening clip

### DETAILED DESCRIPTION OF THE INVENTION

The following describes the technical solutions in the embodiments of the invention in a clear and complete manner with reference to the accompanying drawings. It is evident that the described embodiments are only part of the invention, not all embodiments. Based on these embodiments, those skilled in the art can derive other embodiments within the scope of the invention without creative efforts.

### Embodiment

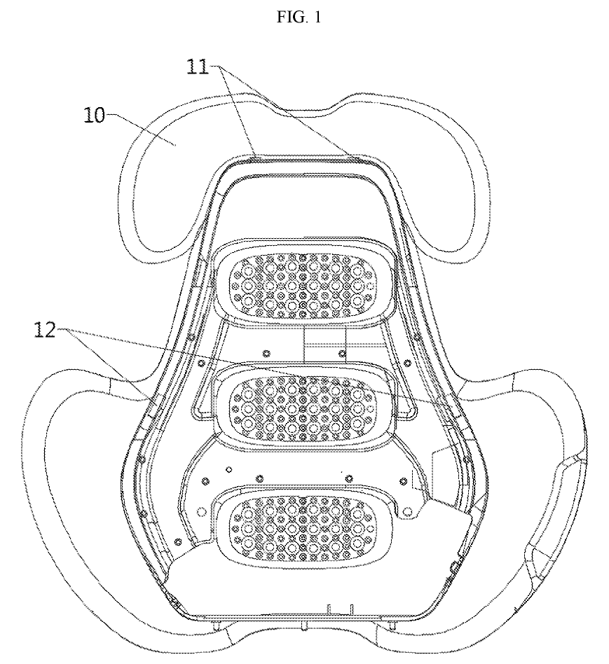

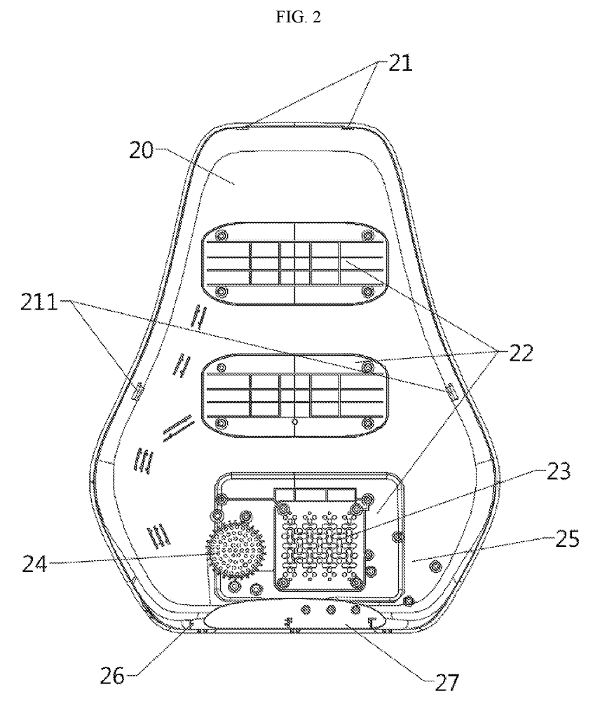

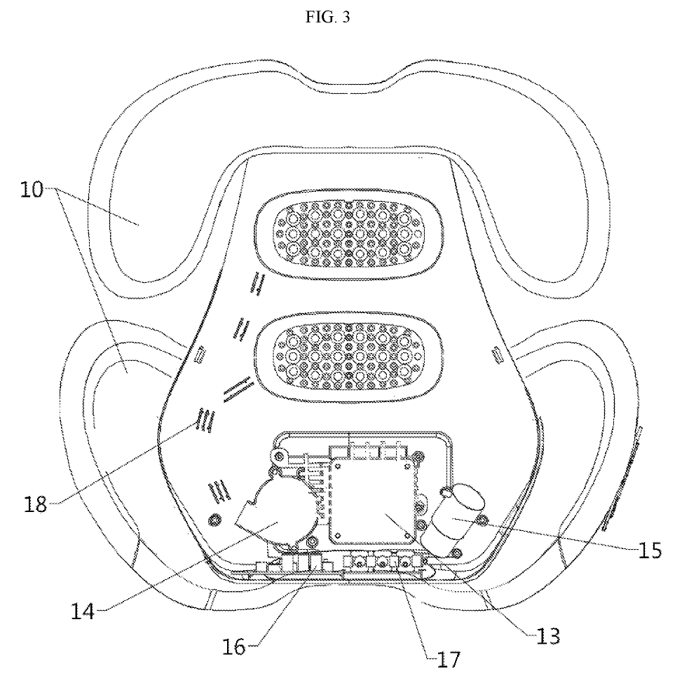

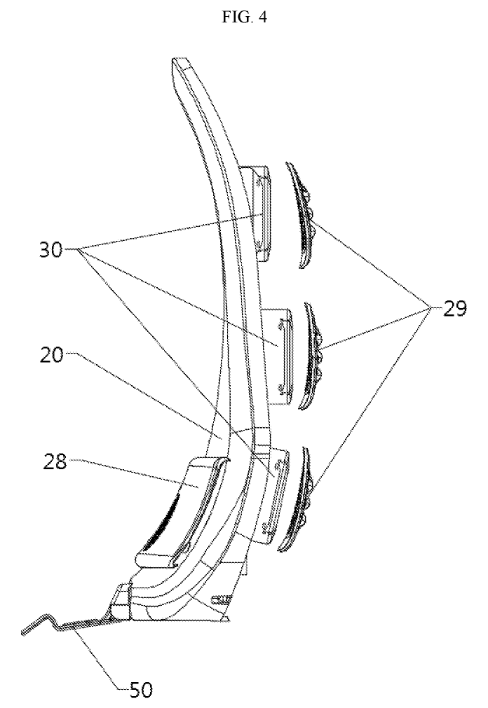

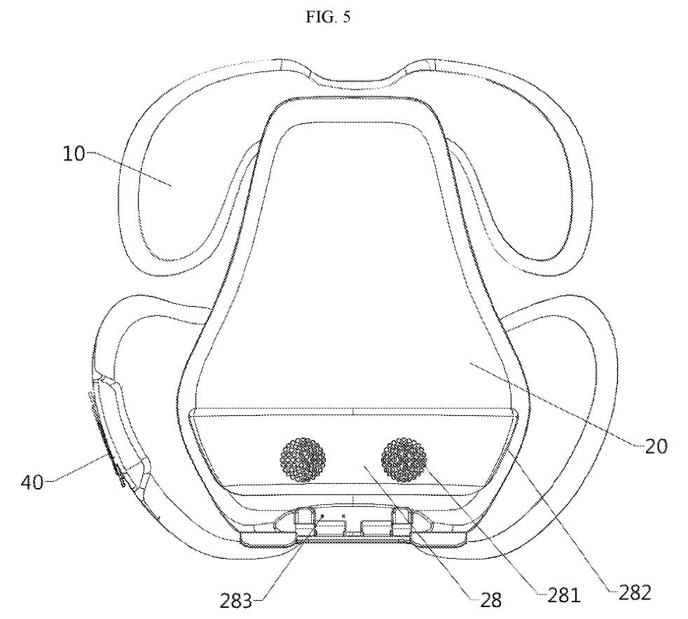

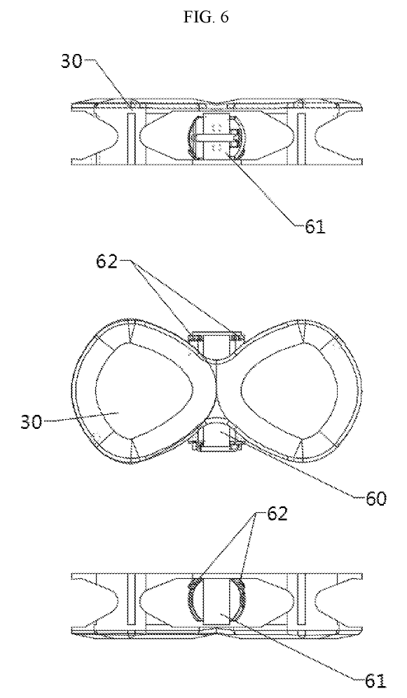

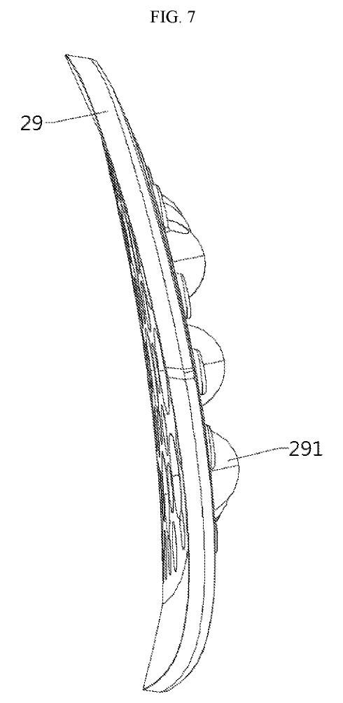

As shown in FIGS. 1 to 7, the invention provides a lumbar cushion, which includes a front panel (10) and a back shell (20). The back shell (20) is detachably mounted on one side of the front panel (10). The front panel (10) is equipped with two hook bodies (11), and the back shell (20) is equipped with two hook slots (21). The hook bodies (11) and hook slots (21) are detachably connected. The front panel (10) has two symmetrically distributed latch slots (12), and the back shell (20) has two symmetrically distributed latch hook bodies (211). The latch hook bodies (211) and latch slots (12) are detachably connected.

By providing hook bodies (11), hook slots (21), latch slots (12), and latch hook bodies (211), the front panel (10) can be easily fixed to one side of the back shell (20). Pulling the front panel (10) forcefully separates it from the back shell (20). One end of the back shell (20) is fixedly installed with a fixing clip (50), allowing the back shell (20) to be conveniently secured to a car seat.

The back shell (20) is equipped with airbag mounting positions (22), first fan mounting positions (23), second fan mounting positions (24), air pump mounting positions (25), circuit board mounting positions (26), and air valve mounting positions (27). There are three airbag mounting positions (22), each fixedly installed with an airbag module (30).

The first fan mounting position (23) is fixedly installed with a first fan (13), and the second fan mounting position (24) is fixedly installed with a second fan (14). The air pump mounting position (25) is fixedly installed with an air pump body (15), which is connected to the airbag module (30) via pipelines. The circuit board mounting position (26) is fixedly installed with a circuit board body (16), and the air valve mounting position (27) is fixedly installed with an air valve body (17). The air valve body (17) is connected to the airbag module (30) via pipelines.

The front panel (10) is equipped with several air duct grooves (18), corresponding to the second fan (14). When the second fan (14) operates, it causes airflow through the air duct grooves (18). The first fan (13), which is a heating fan, heats the air entering the air duct grooves (18).

When the air pump body (15) operates, it inflates the airbag modules (30), causing them to expand. The air valve body (17) deflates the airbag modules (30), causing them to shrink.

The back shell (20) is equipped with an air guide plate (28) on the side opposite the front panel (10). The air guide plate (28) has two honeycomb-shaped front air inlets (281) in the middle and side air inlets (282) at both ends. Air flows through these inlets into the cavity between the front panel (10) and the back shell (20). The air guide plate (28) also features two air valve exhaust holes (283) corresponding to the exhaust ports of the air valve body (17).

The front panel (10) is equipped with three soft cushions (29) on the side facing away from the back shell (20). These soft cushions (29) correspond to the airbag modules (30) and feature several evenly distributed air outlets (291). When the driver’s lumbar region presses against the soft cushions (29), the airflow from the air duct grooves (18) is directed through the air outlets (291), improving comfort.

Each airbag module (30) is fixedly installed with a vibration module (60), which is electrically connected to the circuit board body (16) along with the first fan (13), second fan (14), air pump body (15), and airbag modules (30). The front panel (10) is fixedly installed with a control panel (40), which is electrically connected to the circuit board body (16). The control panel (40) allows the driver to operate and control the components through the circuit board body (16), including adjusting the vibration frequency and intensity of the vibration modules (60) to provide a customized massage.

The vibration module (60) includes a fixing strap (61) and a power cord fastening clip (62). The fixing strap (61) secures the vibration module (60) to the airbag module (30). The fastening clip (62) organizes the power cord, preventing it from tangling.

### Working Principle

When the lumbar cushion is secured to a car seat using the fixing clip (50), the driver’s lumbar region rests against the front panel (10) and the three soft cushions (29). The driver uses the control panel (40) to activate the first fan (13), second fan (14), air pump body (15), airbag modules (30), and vibration modules (60).

External air enters through the front and side air inlets (281, 282) into the cavity and air duct grooves (18). The first fan (13) heats the air, while the second fan (14) circulates it through the air duct grooves (18), creating a high-speed stream of warm air that is directed at the driver’s lumbar region through the air outlets (291).

Simultaneously, the air pump body (15) inflates the airbag modules (30), providing support to the driver’s lumbar region and enhancing comfort. The vibration modules (60) produce vibrations to massage the driver’s lumbar region, adjustable via the control panel (40).

When disassembly is needed, the driver pulls the front panel (10) away from the back shell (20), detaching the hook bodies (11) and hook slots (21) as well as the latch hook bodies (211) and latch slots (12). This allows for maintenance of the internal components. Reattaching is achieved by pressing the front panel (10) back into place.

It will be apparent to those skilled in the art that various modifications, adaptations, and variations can be made to the present invention without departing from its spirit and scope. Accordingly, such modifications and variations are intended to be included within the scope of the appended claims and their equivalents.

What is claimed is:

1. A lumbar cushion, comprising: a lumbar cushion front panel (10); and a lumbar cushion back shell (20), wherein
the lumbar cushion back shell (20) is detachably mounted on one side of the lumbar cushion front panel (10),
the lumbar cushion back shell (20) is provided with an airbag mounting position (22), a first fan mounting position (23), a second fan mounting position (24), an air pump mounting position (25), a circuit board mounting position (26), and an air valve mounting position (27), with three airbag mounting positions (22) set up,
each of the three airbag mounting positions (22) is fixedly installed with an airbag module (30), the first fan mounting position (23) is fixedly installed with a first fan (13), the second fan mounting position (24) is fixedly installed with a second fan (14), the air pump mounting position (25) is fixedly installed with an air pump body (15), which is connected to the airbag module (30) via pipelines, the circuit board mounting position (26) is fixedly installed with a circuit board body (16), the air valve mounting position (27) is fixedly installed with an air valve body (17), which is connected to the airbag module (30) via pipelines, and the lumbar cushion front panel (10) is provided with several air duct grooves (18) corresponding to the second fan (14),
the side of the lumbar cushion back shell (20) away from the lumbar cushion front panel (10) is provided with an air guide plate (28), and the side of the lumbar cushion front panel (10) away from the lumbar cushion back shell (20) is provided with three soft cushions (29), and
each of the three airbag modules (30) is fixedly installed with a vibration module (60), and the circuit board body (16) is electrically connected to the first fan (13), the second fan (14), the air pump body (15), the airbag module (30), and the vibration module (60) via wires.

2. The lumbar cushion according to claim 1, wherein the lumbar cushion front panel (10) is provided with two hook bodies (11), and the lumbar cushion back shell (20) is provided with two hook slots (21), with the hook bodies (11) and hook slots (21) being detachably connected.

3. The lumbar cushion according to claim 1, wherein the lumbar cushion front panel (10) is provided with two symmetrically distributed latch slots (12), and the lumbar cushion back shell (20) is provided with two symmetrically distributed latch hook bodies (211), with the latch hook bodies (211) and latch slots (12) being detachably connected.

4. The lumbar cushion according to claim 1, wherein the lumbar cushion front panel (10) is fixedly installed with a control panel (40), which is electrically connected to the circuit board body (16) via wires.

5. The lumbar cushion according to claim 1, wherein one end of the lumbar cushion back shell (20) is fixedly installed with a fixing clip (50).

6. The lumbar cushion according to claim 1, wherein the middle part of the air guide plate (28) is provided with two front air inlets (281), the front air inlets (281) being honeycomb-shaped, both ends of the air guide plate (28) are provided with side air inlets (282), and the air guide plate (28) is further provided with two air valve exhaust holes (283) corresponding to the exhaust ports of the air valve body (17).

7. The lumbar cushion according to claim 1, wherein the soft cushions (29) correspond to the airbag modules (30), and each of the three soft cushions (29) is provided with several evenly distributed air outlets (291).

8. The lumbar cushion according to claim 1, wherein the vibration module (60) includes a fixing strap (61) and a power cord fastening clip (62), the vibration module (60) is fixedly installed on the airbag module (30) via the fixing strap (61), and the power cord fastening clip (62) is used to secure the power cord of the vibration module (60).
